(19) United States
(12) Patent Application Publication
(10) Pub. No.: US 2025/0192562 A1
(43) Pub. Date: Jun. 12, 2025

(54) SYSTEM AND METHOD FOR NETWORKING ELECTRIC VEHICLES FOR ENHANCED POWER AND ENERGY MANAGEMENT OF SITE LOADS

(71) Applicant: Morel Energy LLC, Delafield, WI (US)

(72) Inventors: Chaitanya Baone, Fremont, CA (US); David G Oteman, Delafield, WI (US)

(21) Appl. No.: 18/975,207

(22) Filed: Dec. 10, 2024

Related U.S. Application Data
(60) Provisional application No. 63/608,748, filed on Dec. 11, 2023.

(51) Int. Cl. H02J 3/32; B60L 55/00; G06Q 10/0631; H02J 7/00

(52) U.S. Cl. CPC H02J 3/322; B60L 55/00; G06Q 10/0631; H02J 7/00032; H02J 7/0013; H02J 7/0048; H02J 7/005; H02J 7/0063; B60L 2210/10; B60L 2210/42; H02J 2203/20

(57) ABSTRACT

The present invention comprises a novel system and method where multiple electric vehicle communicate with their peers at every time interval to determine the optimal utilization of power and energy from the different electric vehicles as a function of their individual available energy and power limits. The method and system to enable this networked power and energy management system are claimed in this invention.

### CROSS REFERENCE TO RELATED APPLICATIONS

This application claims priority to U.S. Provisional Patent Application. 63/608,748, which was filed on Dec. 11, 2023 and entitled “SYSTEM AND METHOD FOR NETWORKING ELECTRIC VEHICLES FOR ENHANCED POWER AND ENERGY MANAGEMENT OF SITE LOADS”, the entirety of which is fully incorporated by reference herein.

### BACKGROUND

When using one or more electric vehicles to supply loads at an off-grid site, the power and energy demands of the loads can exceed the power ratings and energy available from a single power conversion unit connected to an electric vehicle. Power is limited by ratings of the power conversion unit, whether onboard or offboard, and energy is governed by how much is available in the electric vehicle. This can impact the ability to provide continuous energy to meet the needs of loads at a site. When multiple electric vehicles are available at the site, there could be sufficient energy available overall to meet the energy demands of the site, but connecting the vehicles without any coordination could lead to sub-optimal usage of available energy, leading to insufficient power and energy delivery to the site loads for the desired duration.

### SUMMARY

A novel system and method are disclosed, where each power conversion unit connected to an electric vehicle communicates the available power and energy with its peers at every time interval and an analytics process determines the optimal utilization of the different units and electric vehicles as a function of their individual available energy and power limits.

### BRIEF DESCRIPTION OF DRAWINGS

FIG. 1 is a block diagram illustrating a system for power conversion from multiple electric vehicles to power an AC site load, in accordance with one or more arrangements; the diagram showing a single respective electric vehicle connected to each power conversion unit.

FIG. 2 is a block diagram illustrating a system for power conversion from multiple electric vehicles to power an AC site load, in accordance with one or more arrangements; the diagram showing multiple electric vehicles connected to each power conversion unit.

FIG. 3 is a block diagram of an example power conversion unit, in accordance with one or more arrangements.

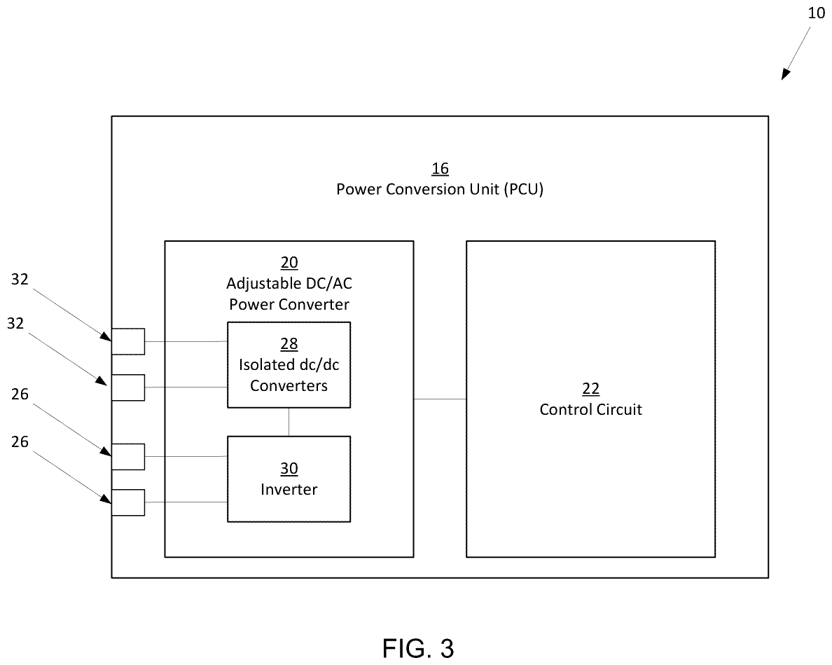

FIG. 4 is a block diagram of an example power conversion unit, in accordance with one or more arrangements; the diagram showing an example circuit for an isolated DC/DC converter that provides a DC voltage from an electric vehicle in an inverter of the power conversion unit.

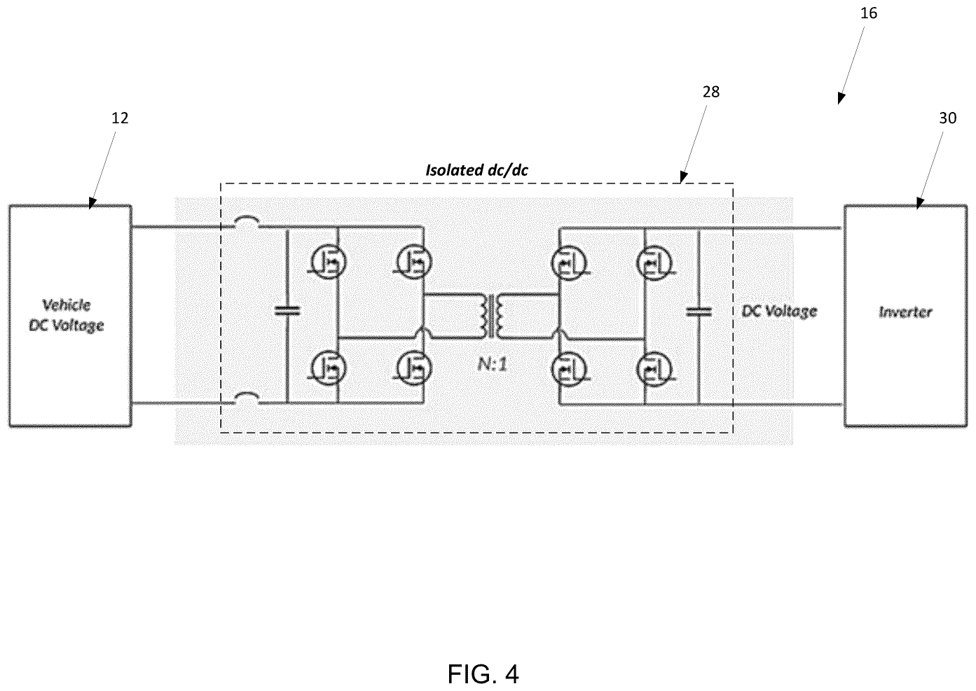

FIG. 5 is a block diagram of an example power conversion unit, in accordance with one or more arrangements; the diagram showing the power conversion unit having DC ports to connect with and draw power from multiple DC power sources.

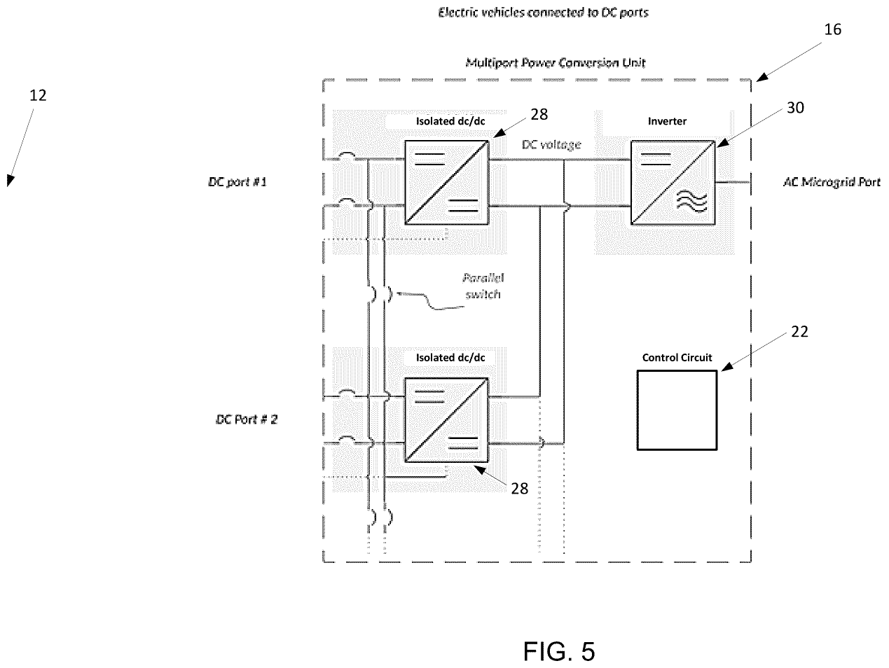

FIG. 6 is a block diagram of the example power conversion unit shown in FIG. 5, in accordance with one or more arrangements; the diagram showing two electric vehicles connected to the power conversion unit; the diagram showing a loaded connected to an output of the power conversion unit via a power distribution network.

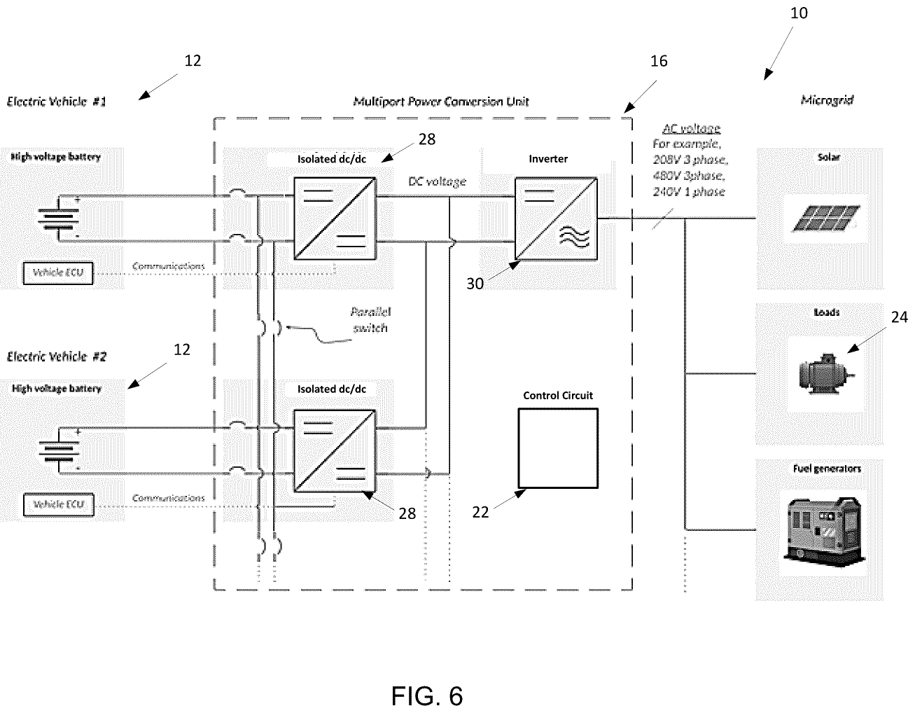

FIG. 7 is a block diagram of the example power conversion unit shown in FIG. 5, in accordance with one or more arrangements; the diagram showing one electric vehicle and one standalone battery connected to the power conversion unit.

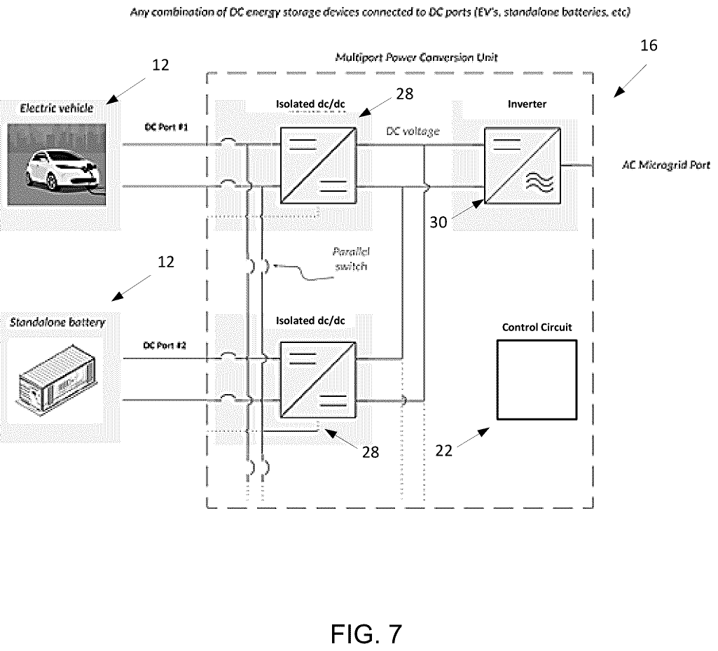

FIG. 8 shows a block diagram of an example control circuit that may be used to implement control circuits of power conversion modules and/or implement various other components and/or processes of system 10, in accordance with one or more arrangements.

FIG. 9 shows a data flow diagram of an example analytics process performed by a control circuit of a power conversion unit for optimization of power conversion, in accordance with one or more arrangements.

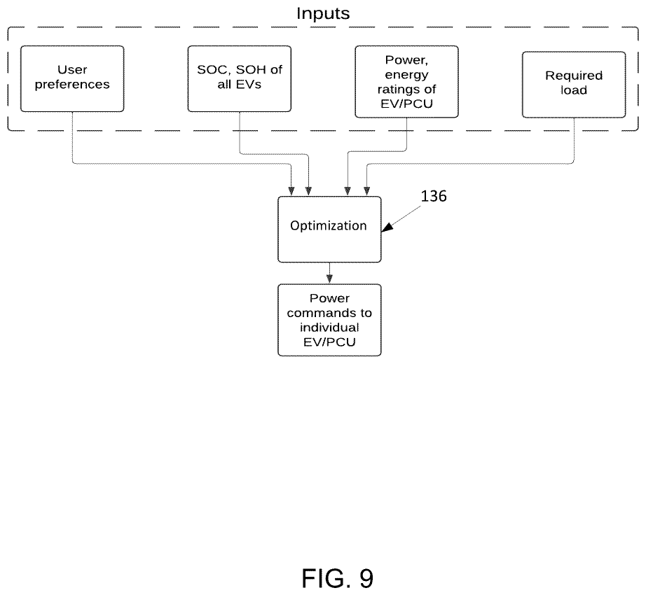

FIG. 10 shows a block diagram of an example method for determining an optimal power draw of DC power sources for power conversion by power conversion units, in accordance with one or more arrangements.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of power distribution from batteries of electric vehicles. However, the embodiments are not so limited. It is appreciated that the embodiments may be adapted for use in other applications which may be improved by the disclosed structures, arrangements and/or methods. The system is merely shown and described as being used in the context of power distribution from batteries of electric vehicles for ease of description and as one of countless examples.

### System 10

With reference to the figures, a novel system 10 and method is presented for networking electric vehicles 12 (or other DC power sources 12) for enhanced power and energy management of site loads. System 10 is formed of components of any suitable size, shape, design, technology, and in any arrangement or configuration to facilitate conversion of power from a set of electric vehicles 12 and/or other DC power sources (e.g., battery, solar banks, etc.) to power an AC load. In one or more embodiments, system 10 includes one or more power conversion units 16 configured to connect with and draw DC power from a plurality DC power sources 12.

In one or more arrangements, the system 10 performs a method for dynamically optimizing the power conversion by the power conversion units 16 during optimization. At every time step, the system 10 computes set points for different vehicle-connected power conversion units as a function of their availability and user preferences, as well as provides an estimate of the duration for which the total load can be met.

In one or more arrangements, the presented system 10 and method take advantage of networking multiple power conversion units 16 connected to electric vehicles 12 (or other DC power source) to allow exchange of key information about available energy and power ratings of the different units. At the time of plugging-in, each vehicle can have a different available energy than its peers. Also, each vehicle may have different allowable energy depending on individual mobility needs set by the user. Accounting for all this information, system 10 is able to determine an optimal approach to discharge the electric vehicles to meet the power and energy demands of site loads.

In some various arrangements, exchange of information between power conversion units 16 and dynamic optimization helps to address several challenges posed by using electric vehicles 12 as power sources at a site. Such challenges may include but are not limited to, for example:
Dynamic nature of loads: The power requirements can change as a function of the type of load. As the power demanded varies, the power supplied would need to adjust appropriately. The claimed networked system will automatically determine the best way to utilize multiple power conversion units connected to vehicles to meet this demand along with providing an estimate for the duration for which this demand can be met.
Available energy in vehicles: when a vehicle is used to provide power, the driver may have different start and end energy settings based on their mobility needs. The networked system accounts for these settings to arrive at the best approach to meet the load without violating the driver preferences.
Vehicle availability could change at any time: a vehicle could be plugged-out or plugged-in as a function of mobility needs at any time. The networked system adapts to these dynamic conditions by computing the power setpoints periodically and continues to provide power and energy to the load using the available vehicles within the constraints set by users.

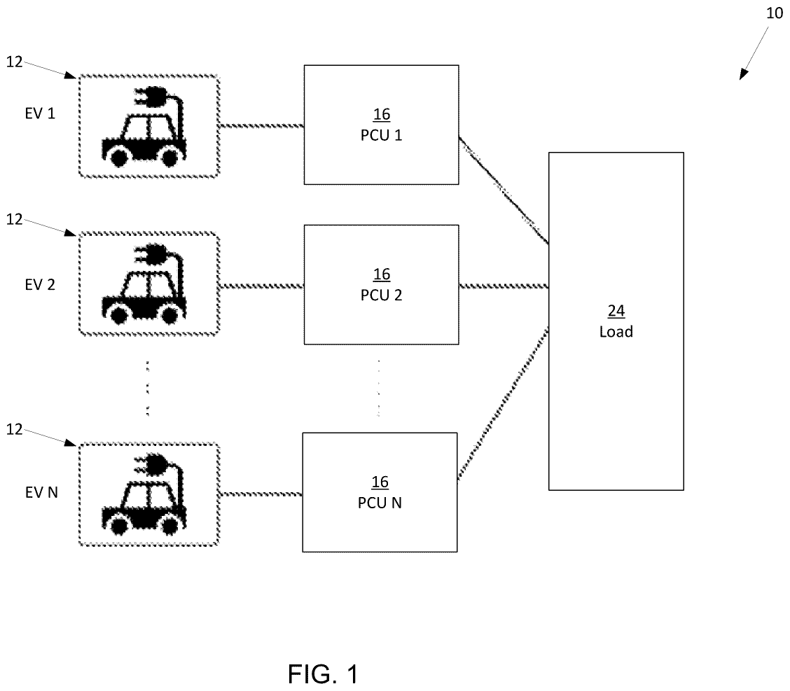

FIG. 1 illustrates an example configuration of system 10, in accordance with one or more arrangements. In this example, system 10 includes a number of power conversion units 16, each connected to a single respective electric vehicle 12. The individual power conversion units obtain and exchange data in real-time regarding the associated vehicle's available state of energy and state of charge to determine optimal power draw from each electric vehicle 12 to power the current load 24.

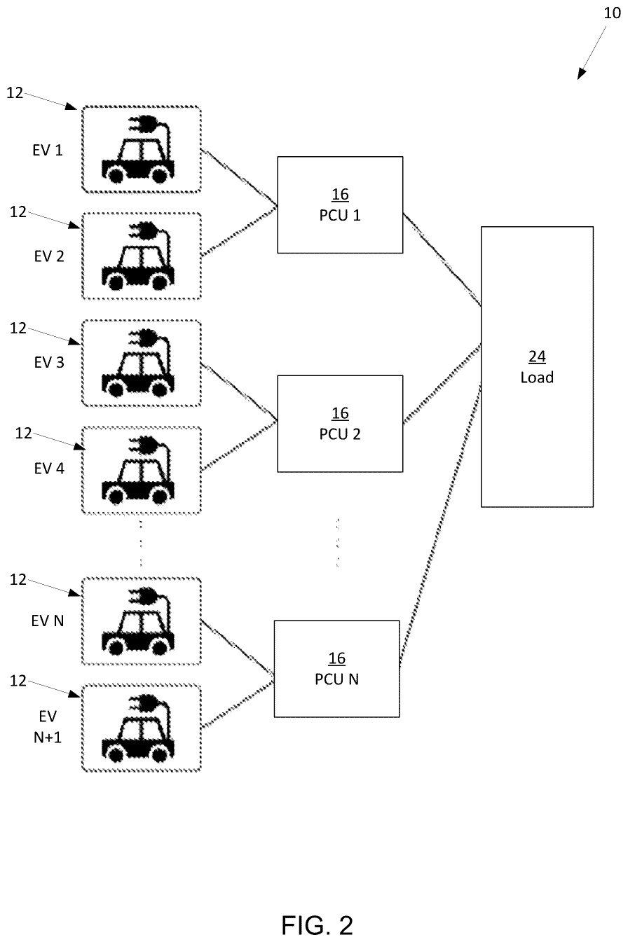

FIG. 2 illustrates another example configuration of system 10, in accordance with one or more arrangements. In this example, multiple electric vehicles 12 are connected to each power conversion unit 16. The individual power conversion units obtain and exchange data in real-time regarding the associated vehicle's available state of energy and state of charge to determine optimal power draw from each electric vehicle 12 to power the current load 24. In a preferred implementation, the various power conversion units communicate with each other in real-time to exchange data regarding the states of various vehicles. This information is then used by an analytics process executed by a control circuit (e.g., control circuit 22 of a designated master power conversion unit 16) to determine the optimal approach to discharge the various electric vehicles and the corresponding dispatch profiles are executed by the individual power conversion units. Such an approach ensures that each power conversion unit has visibility into the real-time data of every vehicle's state of energy and state of charge, which allows optimal utilization of all electric vehicles 12 to meet site load. However, the arrangements are not so limited to optimization of all vehicles. Rather, it is contemplated that in some arrangements, control circuits 22 of power conversion units 16 may be configured to additionally or alternatively locally optimize power drawn from electric vehicles 12 connected to the respective power conversion unit 16.

### Power Conversion Unit(s) 16

Power conversion units are formed of any suitable size, shape, design, technology, and in any arrangement or configuration to convert DC power from a plurality of DC power sources 12 to power one or more AC loads 24 and dynamically adjust DC power drawn from the respective DC power sources 12 to facilitate optimization of the power conversion. In one or more arrangements, as is shown, power conversion units 16 each include an adjustable DC to AC converter 20 and a control circuit 22

In one or more arrangements, the adjustable DC to AC converters 20 are formed of any suitable size, shape, design, technology, and in any arrangement or configuration to selectively draw DC power from a plurality of DC power sources 12 as directed by control circuit 22. In one or more arrangements, as is shown, adjustable DC to AC converters 20 include a set of input connectors 32 to facilitate connection with DC power sources 12, a set of one of more output connectors 26 to facilitate provision of AC power to one or more load devices 14, respective isolated DC/DC converters 28, and a DC to AC inverter 30, among other components.

In one or more arrangements, a plurality of power conversion units 16 are communicatively coupled together and are configured to exchange information to coordinate and optimize operation of the power conversion units 16.

For example, in one or more arrangements, a control circuit 22 of each power conversion unit 16 is configured to communicate the status data (e.g., available power and energy) with a designated master controller of its peers at every time interval, at which the data is evaluated to determine how to optimally utilize the different power conversion units 16 and the DC power sources 12 (e.g., electric vehicles) as a function of their individual available energy and power limits.

In some various arrangements, power conversion units 16 may utilize various methods and/or means to designate a master controller including but not limited to: manual designation by a user, automated election and/or negotiation between power conversion units 16, and/or any other suitable method or means. While some various arrangements may be primarily described as having a designated one of the power conversion units 16 operating as a master controller for performing optimization, the arrangements are not so limited. Rathere, it is contemplated that in some arrangements, power conversion units 16 may be configured to communicate the status data to a separate central control circuit (not shown), at which the status data is evaluated to perform optimization.

### Control Circuit 102

Control circuit 102 is formed of any suitable size, shape, design and is configured to receive and process data received from power conversion units, vehicles/batteries, or other components of system 10 and/or input from user interface 104.

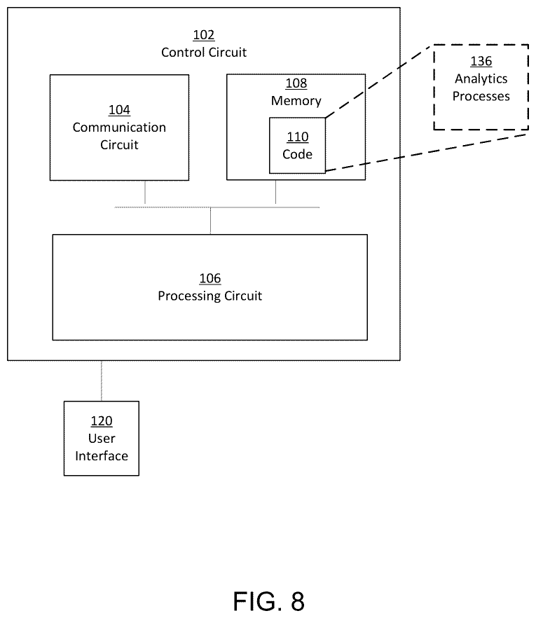

FIG. 8 shows a block diagram of an example control circuit that may be used to implement control circuits 102 of power conversion modules 16 and/or implement various other components and/or processes of system 10. In the arrangement shown, as one example, control circuit 102 includes a communication circuit 110, a processing circuit 112, and a memory 114 having software code 116 or instructions that facilitate the operation of system 10.

Processing circuit 112 may be any computing device that receives and processes information and outputs commands according to software code 116 stored in memory 114. For example, in some various arrangements, processing circuit 112 may be discrete logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 114. Memory 114 may be any form of information storage such as flash memory, ram memory, dram memory, a hard drive, or any other form of memory,

Processing circuit 112 and memory 114 may be formed of a single combined unit. Alternatively, processing circuit 112 and memory 114 may be formed of separate but electrically connected components. Alternatively, processing circuit 112 and memory 114 may each be formed of multiple separate but communicatively connected components. Software code 116 is any form of instructions or rules that direct how processing circuit 112 is to receive, interpret and respond to information to operate as described herein. Software code 116 or instructions are stored in memory 114 and accessible to processing circuit 112.

Communication circuit 110 is formed of any suitable size, shape, design, technology, and in any arrangement and is configured to facilitate communication with electric vehicles 12 (or other DC power sources), other power conversion units 16, and/or other components of system 10. In one or more arrangements, as one example, communication circuit 110 includes a transmitter (for one-way communication) or transceiver (for two-way communication). In various arrangements, communication circuit 110 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, FM/VHF/UHF networks, and/or any other communication protocol, technology or network,

### Analytics Processes 136

In one or more arrangements, software code 116 is configured to implement one or more analytics processes 136 configured to process data received from vehicles/power sources and/or other power conversion units, and determine an optimal power draw from the vehicles/power sources 12 to provide power for current load 24 with maximal efficiency.

In various different arrangements, control circuits 22 of power conversion units 16 may collect and exchange various different information to facilitate determination of the optimal power conversion approach for a given load 24 and may provide various output information specifying the determined optimal power conversion. As an illustrative example, in one or more arrangements, the analytics processes 136 may implement a non-linear optimization process utilizing the following inputs, outputs and solution approach. These inputs and outputs form the data elements of the communications protocol.

In this example, the following data elements are provided as “Inputs”:
Power and energy ratings of each power conversion unit and associated electric vehicle.
Load demand at any given time step.
Status (ON/OFF), state of energy (kWh) and remaining available energy of each electric vehicle at any given time step.
Weights for each electric vehicle-for example, some vehicles may be weighed higher than others by the site owner/operator if there is a preference on which vehicle(s) need to be used first for powering loads.

In one or more arrangements, the following data elements constitute the “Outputs” of the optimization process performed by analytics processes 136:
Power commands for each electric vehicle at any given time step
Amount of energy that can be provided for the remaining duration of the day

At any given time step, the following non-linear optimization problem is solved in a preferred implementation.

In some various arrangements, analytics processes 136 may utilize various methods and/or means to perform optimization of the power conversion. Additionally, in various arrangements the analytics processes 136 may be configured to optimize the power conversion for various different performance parameters or objectives, including but not limited to, for example: power availability, electric vehicle availability/flexibility, battery lifespan, etc.

As an illustrative example, in one or more arrangements, analytics processes 136 may be configured to maximize over the available time duration, the sum of energies across all electric vehicles that are being used to power the site load, subject to the following constraints:
For each power conversion unit, the output power should be less than the rated power
Load power should equal the sum of output power from all the power conversion units
For each power conversion unit, the available energy equals power multiplied by time subtracted from the energy from the previous time step.
For each power conversion unit, the output energy should be less than the available energy from each electric vehicle

Given the dynamic nature of the problem, modeling it in a framework such as above enables leveraging standard mathematical optimization solvers. Also, as the problem size grows to include larger numbers of vehicles the complexity of this framework is believed to scale better than a rules based approach.

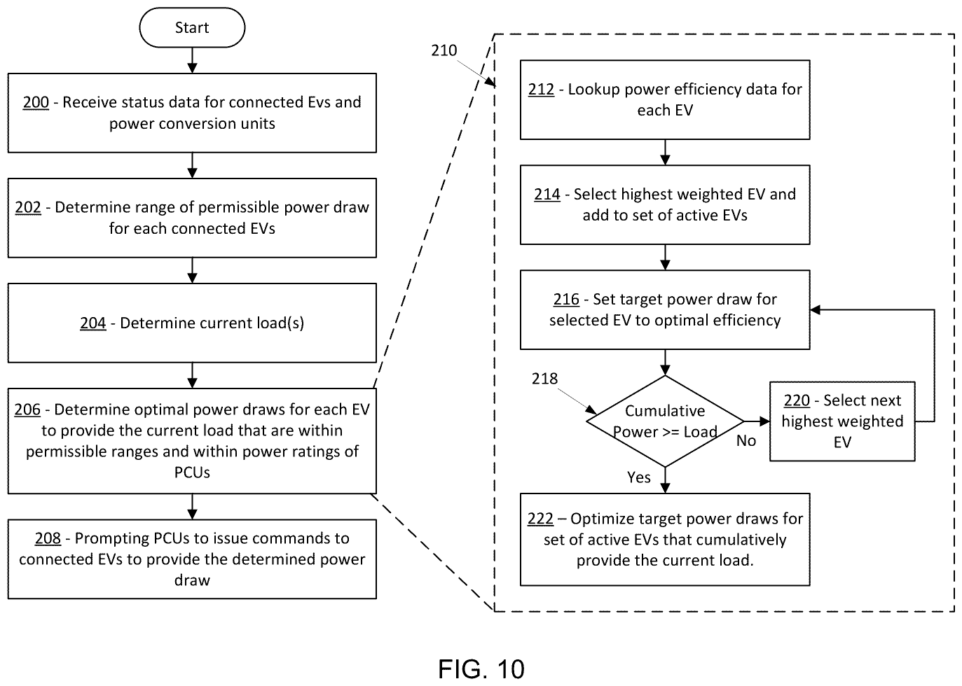

As an illustrative example, FIG. 10 shows a block diagram of an example high-level process for determining an optimal power draw of DC power sources for power conversion by power conversion units, in accordance with one or more arrangements.

In this example, the process is performed in each time interval at which status data is updated. At process block 200, new status data is received for connected electric vehicles 12 and power conversion units 16. At process block 202, a range of permissible power draw is determined for each connected electric vehicle (e.g., based on the above described constraints). At process block 204, a current load is determined. At process block 206, optimal power draws are determined for electric vehicles to provide the current load within the permissible power draw ranges and power ratings of the power conversion units 16.

Block 210 shows an example process for performing such optimization, in accordance with one or more arrangements. In this example, the process 210 determines optimal power draw for each electric vehicle and iteratively allocates electric vehicles order of weighting to provide their optimal power draw until sufficient power is allocated to power the current load. As process block 212, power efficiency data is retrieved for each connected electric vehicle (e.g., from the vehicle, user specifications, a database, etc.). At process block 214, the highest weighted electric vehicle is selected and added to a set of active electric vehicles. At process block 216, the target power draw is set to a determined power draw providing optimal efficiency. At decision block 218, if a cumulative power to be provided by the set of active electric vehicles is not greater than or equal to the current load, the process proceeds to block 220. At block 220, the next highest weighted electric vehicle is selected and the process loops back to process block 216. The process loops in this manner until cumulative power to be provided by the set of active electric vehicles is greater than or equal to the current load at decision block 218. The process then proceeds to process block 222, where the target power draws to be provided by the set of active electric vehicles is optimized for the current load (e.g., reduced for one or more electric vehicles if cumulative target power is greater than that needed for the current load. After determining optimal power draws, the process proceeds to process block 208, where power conversion units 16 are prompted to issue commands to cause electric vehicles to provide the determined optimal power draws.

### Machine Learning

However, the arrangements are not limited to the example processes disclosed herein for optimization and/or power conversion. In one or more embodiments, analytics processes 136 and/or other processes and/or components of system 10 may be configured and arranged to monitor, learn, and modify one or more features, functions, and/or operations of the system. For example, in one or more arrangements, analytics processes 136 may be configured to additionally or alternatively process the status data using one or more classifiers or state machines that are trained to determine optimal power draws to maximize available power for current and/or predicted loads. For instance, analytics processes 136 may be configured to monitor and/or analyze sensor data and/or operation of system 10. As one example, in one or more arrangements, analytics processes 136 may be configured to analyze the provided data and learn, over time, data metrics indicative of parameter values that are optimal for the operation of system 10. Such learning may include, for example, generation and refinement of artificial intelligence algorithms configured to map input data values to outcomes of interest or to operation of system 10. In various embodiments, analysis by the analytics processes 136 may include various guided and/or unguided training of artificial intelligence algorithms including, but not limited to, for example: neural networks, genetic algorithms, support vector machines, k-means, kernel regression, discriminant analysis and/or various combinations thereof. In different implementations, analysis may be performed locally, remotely, or a combination thereof.

### User Interface 104

In one or more arrangements, system 10 provides an interface for users to configure and/or monitor operation of power conversion units 16. User interface 104 is formed of any suitable size, shape, design, technology, and in any arrangement and is configured to facilitate user monitoring, control, and/or adjustment of various components of system 10. In one or more arrangements, as one example, user interface 104 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input, Optionally, in one or more arrangements, user interface 104 includes a display (not shown). Display is formed of any suitable size, shape, design, technology, and in any arrangement and is configured to display information of settings, sensor readings, and/or other information pertaining to operation or system 10. In one or more arrangements, display may include, for example, LED lights, meters, gauges, screen or monitor of a computing device, tablet, and/or smartphone. Additionally, or alternatively, in one or more arrangements, the inputs and/or display may be implemented on a separate device that is communicatively connected to control circuit 102. For example, in one or more arrangements, the operation of control circuit 102 may be customized or controlled using a smartphone or other computing device that is communicatively connected to the control circuit 102 (e.g., via Bluetooth, WIFI, and/or the internet).

It will be appreciated by those skilled in the art that other various modifications could be made to the device without parting from the spirit and scope of this disclosure. All such modifications and changes fall within the scope of the claims and are intended to be covered thereby.

1. A system for controlling the power drawn from a plurality of electric vehicles to power a load at a site disconnected from the power grid, the system comprising:
at least one power conversion unit;
at least one control circuit;
wherein the at least one control circuit is configured to:
receive a set of data indicative of status of batteries of the plurality of electric vehicles and current requirements of the load; and
control the power drawn from the plurality of electric vehicles connected to the at least one power conversion unit based on the status of batteries data of the plurality of electric vehicles and the current requirements of the load.

2. The system of claim 1, wherein the at least one control circuit forms part of the at least one power conversion unit.

3. The system of claim 1, wherein the at least one control circuit is communicatively connected to the at least one power conversion unit via one or more data networks.

4. The system of claim 1, wherein the at least one control circuit is communicatively configured to control power drawn from the plurality of electric vehicles, based on the set of data, to optimize power efficiency of batteries of the plurality of electric vehicles.

5. The system of claim 1, wherein the set of data indicates state of charge of the batteries of the plurality of electric vehicles.

6. The system of claim 1, wherein the set of data indicates state of charge of the state of health of the batteries of the plurality of electric vehicles.

7. The system of claim 1, further comprising of at least one standalone battery energy storage connected to the at least one power conversion unit, wherein the processor is further configured to:
control the power drawn from the at least one standalone battery energy storage based on the set of data.

8. A system for controlling the power drawn from a plurality of electric vehicles to power a load at a site disconnected from the power grid, the system comprising:
a plurality of power conversion units;
wherein the plurality of power conversion units are respectfully connected to one or more of the plurality of electric vehicles;
wherein the plurality of power conversion units are communicatively connected to at least one control circuit;
wherein the at least one control circuit is configured to:
receive a set of data from the plurality of power conversion units indicative of status of batteries of the plurality of electric vehicles and current requirements of the load;
determine target power draws from respective ones of the plurality of electric vehicles sufficient to power the load based on the set of data; and
prompt the plurality of power conversion units to cause the plurality of electric vehicles to provide the target power draws to the plurality of power conversion units respectively connected thereto.

9. The system of claim 8, wherein the at least one control circuit forms part of one of the power conversion unit.

10. The system of claim 8, wherein the control circuit is communicatively connected to the plurality of power conversion units via one or more data networks.

11. The system of claim 8, wherein the at least one control circuit is configured to control power drawn from the plurality of electric vehicles, based on the set of data, to optimize power efficiency of batteries of the plurality of electric vehicles.

12. The system of claim 8, wherein the set of data indicates state of charge of the batteries of the plurality of electric vehicles.

13. The system of claim 8, wherein the set of data indicates state of charge of the state of health of the batteries of the plurality of electric vehicles.

14. The system of claim 8, further comprising of at least one standalone battery energy storage connected to one of the plurality of power conversion units, wherein the processor is further configured to control the power drawn from the at least one standalone battery energy storage based on the set of data.

15. A method for controlling the power drawn from a plurality of electric vehicles connected to one or more power conversion units to meet the load at a site disconnected from the power grid, the method comprising:
receiving a set of data from the one or more power conversion units indicating:
the load demand, power and energy ratings of each power conversion unit and the electric vehicles, and stored energy status of the plurality of electric vehicles;
allocating a set of the plurality of electric vehicles to provide power for the load based on the received set of data;
determining target power draws from the set of the plurality of electric vehicles sufficient to power the load based on the set of data; and
prompting the plurality of power conversion units to cause the set of the plurality of electric vehicles to provide the target power draws to the plurality of power conversion units respectively connected thereto.

16. The method of claim 15, wherein the set of data indicates status (ON/OFF), state of energy, state of health and remaining available energy of each of the plurality of electric vehicles.

17. The method of claim 15, wherein the allocating a set of the plurality of electric vehicles to provide power for the load includes determining weights for each electric vehicle based on site owner/operator preferences.
